(19) United States
(12) Patent Application Publication
(10) Pub. No.: US 2009/0319744 A1
(43) Pub. Date: Dec. 24, 2009

(54) Digital Television, Memory Controller, and Method for Controlling Access of a Memory Device

(75) Inventor: Hsiang-I Huang, Hsinchu City (TW)

Correspondence Address: GROSSMAN, TUCKER, PERREAULT & PFLEGER, PLLC, 55 SOUTH COMMERICAL STREET, MANCHESTER, NH, 03101, US

(73) Assignee: MEDIATEK INC., Hsinchu (TW)

(21) Appl. No.: 12/142,882

(22) Filed: Jun. 20, 2008

(51) Int. Cl. G06F 12/00

(52) U.S. Cl. 711/167

(57) ABSTRACT

A digital television, a memory controller and a method for controlling access of a memory device are provided. The digital television comprises the memory device and the memory controller. The memory controller comprises a storage buffer and a clock adjustment device. The storage buffer buffers a data read from the memory device according to a reference clock source. The clock adjustment device provides the reference clock source and determines whether to adjust the reference clock source in response to the data. The method comprises steps of: providing a reference clock source; buffering a data read from the memory device according to the reference clock source; and determining whether to adjust the reference clock source in response to the data.

### CROSS-REFERENCES TO RELATED APPLICATIONS

Not applicable.

### BACKGROUND OF THE INVENTION

1. Field of the Invention

The present invention relates to a digital television, a memory controller, and a method for controlling access of a memory device; more specifically, relates to a digital television, a memory controller and a method for maintaining an appropriate delay during data access.

2. Descriptions of the Related Art

Double data rate (DDR) memories are used frequently nowadays because data in a DDR memory can be accessed at both rising edges and falling edges. In addition to DDR memories, some electrical devices are also required to control data access. A conventional memory control system 1 is shown as FIG. 1. The memory control system 1 comprises a DDR SDRAM 11, a memory controller 13, printed circuit board (PCB) traces 15, 17, and a leading wire 19. The DDR SDRAM 11 comprises pads 111, 113. The memory controller 13 comprises pads 1301, 1303. The PCB trace 15 represents a route of a data DQ on a PCB from the pad 111 to the pad 1301, and the PCB trace 17 represents a route of a clock DQS on the PCB from the pad 113 to the pad 1303. The leading wire 19, connected between the DDR SDRAM 11 and the memory controller 13, is configured to transmit commands from the memory controller 13 to the DDR SDRAM 11, wherein the commands comprise READ, WRITE, REFRESH, and PRECHARGE, etc. The DDR SDRAM 11 operates in response to the commands.

The memory controller 13 further comprises wires and buffers 1305, 1307, 1309, a delay element 1311, a latch 1313, a delay loop lock (DLL) 1315, and a command unit 1317. The data DQ is transmitted through the pad 111, the PCB trace 15, the pad 1301, the wires and buffers 1305 and becomes a data DQX before it reaches the latch 1313. Compared to the data DQ, the data DQX has a delay. The clock DQS is transmitted through the pad 113, the PCB trace 17, the pad 1303, the wires and buffers 1307, the delay element 1311, the wires and buffers 1309 and becomes a clock DQSX before it reaches the latch 1313. Compared to the clock DQS, the clock DQSX has a delay as well.

The timing diagram of the data DQ, DQX, and the clocks DQS, DQSX is shown in FIG. 2. When the command unit 1317 issues, for example, a read command to the DDR SDRAM 11 via the leading wire 19, the DDR SDRAM 11 sends the data DQ with a pre-determined burst length and the clock DQS, wherein the pre-determined burst length is equal to 4 in the memory control system 1. The clock DQS is used to sample the data DQ. Since the clock DQS and the data DQ are edge-aligned, the DLL 1315 is assigned to delay the clock DQS, for example, ¼ clock cycle in order to establish enough setup time and hold time margins. More particularly, the DLL 1315 receives an internal clock REFCK as a reference clock to create the ¼ clock cycle, and the delay element 1311 delays the clock DQS so that the timing of the clock DQSX reaching the latch 1313 is ¼ clock cycle later than that of the data DQX.

The mark X in FIG. 2 denotes the propagation time of the data DQ from the DDR SDRAM 11 to the latch 1313, i.e., the time period from the data DQ being sent to the data DQX being generated. The mark Y in FIG. 2 denotes the propagation time of the clock DQX from the DDR SDRAM 11 to the latch 1313, i.e., the time period from the clock DQS being sent to the clock DQSX being generated. In the other words, the mark X in FIG. 2 is a sum of data delay resulting from the pad 111, the PCB trace 15, the pad 1301, and the wires and buffers 1305, and the mark Y in FIG. 2 is a sum of clock delay resulting from the pad 113, the PCB trace 17, the pad 1303, the wires and buffers 1307, the delay element 1311, and the wires and buffers 1309.

According to the above descriptions, (X-Y) must be equal to ¼ clock cycle to get enough setup time and hold time. In order to accomplish this goal, at least the following requirements should be met. First, the I/O delays of the pad 111 and the pad 113 are well balanced. Second, the delays of the PCB trace 15 and the PCB trace 17 are well balanced. Third, the delays of the pad 1301 and the pad 1303 are well balanced. Fourth, the delays of the wires and buffers inside the memory controller 13 without considering the delay element 1311 are well balanced. Finally, the delay element 1311 provides exact ¼ clock delay.

Even if these requirements are perfectly tuned during simulation, it is still hard to make (X-Y) to be exact ¼ clock cycle physically because there are many manufacturing and operating environment factors unable to be pre-considered. Once the delay deviates, the data access would be erroneous. Therefore, a solution to maintaining an appropriate delay during data access is desired in the industrial field.

### SUMMARY OF THE INVENTION

One object of this invention is to provide a memory controller for controlling access of a memory device. The memory controller comprises a storage buffer and a clock adjustment device. The storage buffer is configured to buffer a data read from the memory device according to a reference clock source. The clock adjustment device is configured to provide the reference clock source and determine whether to adjust the reference clock source in response to the data.

Another object of this invention is to provide a method for controlling access of a memory device. The method comprises the following steps: providing a reference clock source; buffering a data read from the memory device according to the reference clock source; and determining whether to adjust the reference clock source in response to the data.

Another object of this invention is to provide a digital television. The digital television comprises a memory device and a memory controller. The memory device is configured to store a data. The memory controller is configured to provide a reference clock source, buffering the data read from the memory device according to the reference clock source, and determines whether to adjust the reference clock source in response to the buffered data.

The present invention is capable of dynamically adjusting the reference clock source by monitoring the data outputted from the storage buffer of the memory controller. Therefore, an appropriate delay during data access can be maintained.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates a block diagram of a memory control system of the prior art;

FIG. 2 illustrates a timing diagram of the memory control system of the prior art;

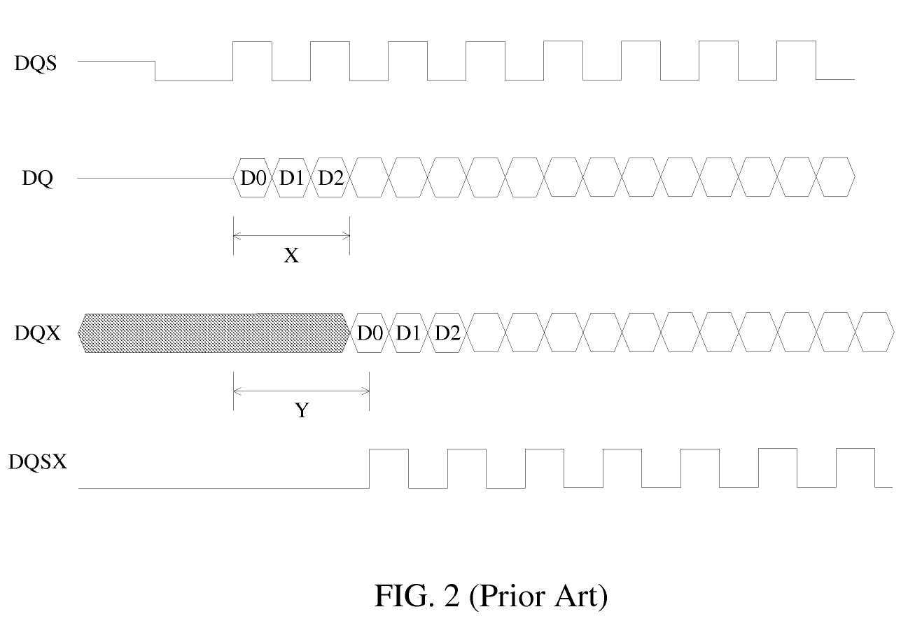

FIG. 3 illustrates a block diagram of a first embodiment of the present invention;

FIG. 4 illustrates a block diagram of a calibrator of the first embodiment;

FIG. 5 illustrates a flow chat of a second embodiment of the present invention; and

FIG. 6 is a further flow chat of the second embodiment.

### DESCRIPTION OF THE PREFERRED EMBODIMENT

In this specification, the term “according to” is defined as “replying to” or “reacting to.” For example, “according to a signal” means “replying to a signal” or “reacting to a signal” without necessity of direct signal reception. The term “in response to” has a definition similar to that of the term “according to.”

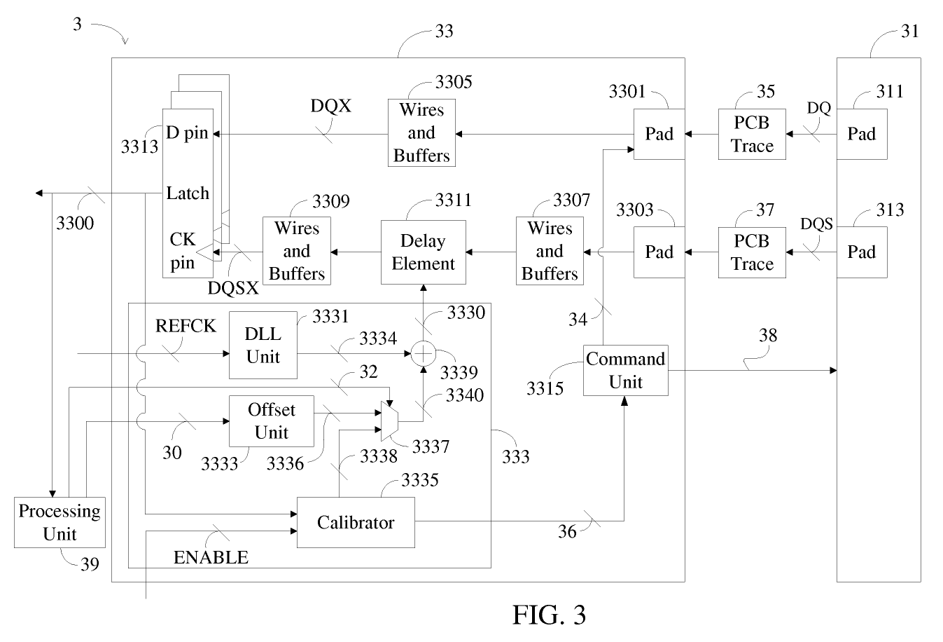

A first embodiment of the present invention is a digital television 3 as illustrated in FIG. 3. The digital television 3 comprises a memory device 31, a memory controller 33, PCB traces 35, 37, a leading wire 38 and a processing unit 39. The memory device 31, such as a DDR SDRAM or a DRAM, stores a data DQ. The memory controller 33 is used to control data access. Some of the tasks of the memory controller 33 are to provide a reference clock source 3330, buffer the data DQ and determine whether to adjust the reference clock source 3330 in response to the buffered data DQ during a READ operation. The PCB trace 35 represents a route of the data DQ on a PCB of the digital television 3, and the PCB trace 37 represents a route of a clock DQS on the PCB. The processing unit 39 is connected to the memory controller 33 to provide information for the memory controller 33 to determine whether to adjust the reference clock source 3330.

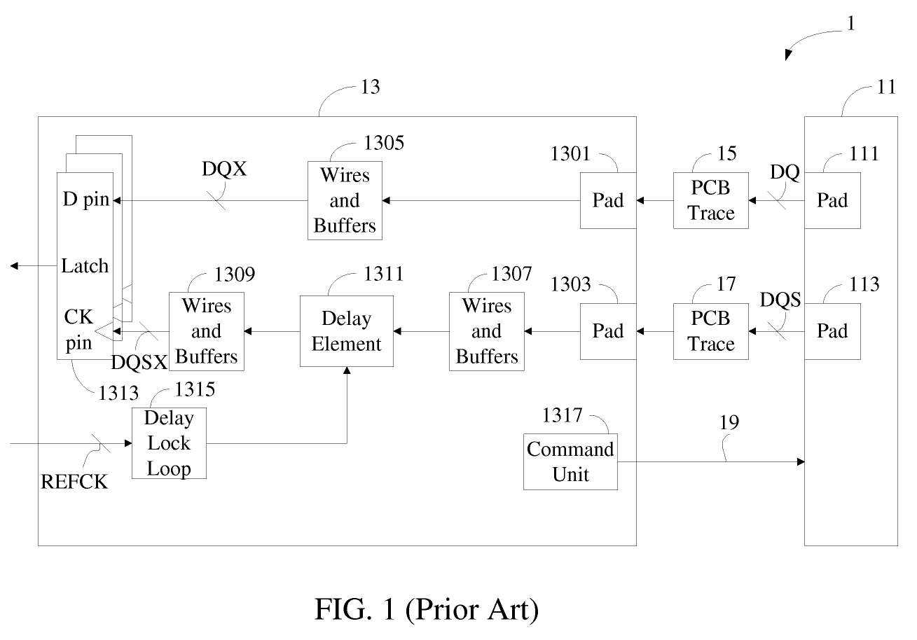

The memory device 31 comprises pads 311, 313. The memory controller 33 comprises pads 3301, 3303, wires and buffers 3305, 3307, 3309, a delay element 3311, a latch 3313, a clock adjustment device 333, and a command unit 3315. The pads 311, 313, 3301, 3303, the wires and buffers 3305, 3307, 3309, and the delay element 3311 are similar to the corresponding component shown in FIG. 1, respectively.

A delay for the clock DQS is variable depending on system requirements, e.g., ½ clock cycle, ¼ clock cycle, or ⅛ clock cycle. In the first embodiment, a delay of ¼ clock cycle is used simply for an exemplification and should not be treated as a limitation of the present invention.

The data DQ is transmitted through the pad 311, the PCB trace 35, the pad 3301, the wires and buffers 3305 and becomes a data DQX before it reaches the latch 3313. The clock DQS is transmitted through the pad 313, the PCB trace 37, the pad 3303, the wires and buffers 3307, the delay element 3311, the wires and buffers 3309 and becomes a clock DQSX before it reaches the latch 3313. Please note that the data DQ, DQX are identical except the time delay. Generally speaking, the data DQ and the clock DQS are simultaneously transmitted from the memory device 31 once the memory device 31 receives a READ command. The latch 3313, a storage buffer, receives the data DQX according to the reference clock source 3330. That is, the latch 3313 holds the data DQX until the clock DQSX reaches the latch 3313. The delay time of the clock DQSX is determined by the delay element 3311 which operates in response to the reference clock source 3330. The reference clock source 3330 is to control the delay element 3311 to provide a delay of ¼ clock cycle on the clock DQS. Rather than providing a fixed clock source, the clock adjustment device 333 is capable of determining whether to adjust the reference clock source 3330 in response to a data 3300 which is the data DQX sent from the latch 3313 after the latch 3313 is triggered by the clock DQSX.

The clock adjustment device 333 comprises a DLL unit 3331, an offset unit 3333, a calibrator 3335, a multiplexer 3337, and an adder 3339. The DLL unit 3331 generates a core delay clock 3334, i.e. ¼ clock cycle, according to an internal clock REFCK, wherein the internal clock REFCK is generated by the digital television 3. The processing unit 39 receives and analyzes the data 3300 to generate a signal 30 after the analysis. In particular, the processing unit 39 analyzes the data 3300 to determine whether the delay is acceptable. If not, the signal 30 will carry information of the adjustment range required. The offset unit 3333, such as a register, generates an offset value 3336 in response to the signal 30. The offset value 3336 is used to be added to the core delay clock 3334 to adjust the delay. Furthermore, the calibrator 3335 directly receives the data 3300 and generates a calibration value 3338 in response to the data 3300. The calibration value 3338 also can be added to the core delay clock 3334 to adjust the delay. The multiplexer 3337 selects one of the offset value 3336 and the calibration value 3338 in response to a selection command 32 generated from the processing unit 39. The selection is determined based on several conditions, such as the functionality or the amounts of power consumption of the offset unit 3333 and the calibrator 3335. The core delay clock 3334 and the selection 3340 are added by the adder 3339 to form the reference clock source 3330 that is then provided to the delay element 3311. The above-mentioned adjustment mechanism may operate during initiation or all the time as long as the data 3300 keeps coming out. In response to the adjusted reference clock source 3330, the delay of the clock DQSX will be optimized. Please note that the offset unit 3333 and the calibrator 3335 do not have to be embedded at the same time. The existence of either one may achieve the delay adjustment.

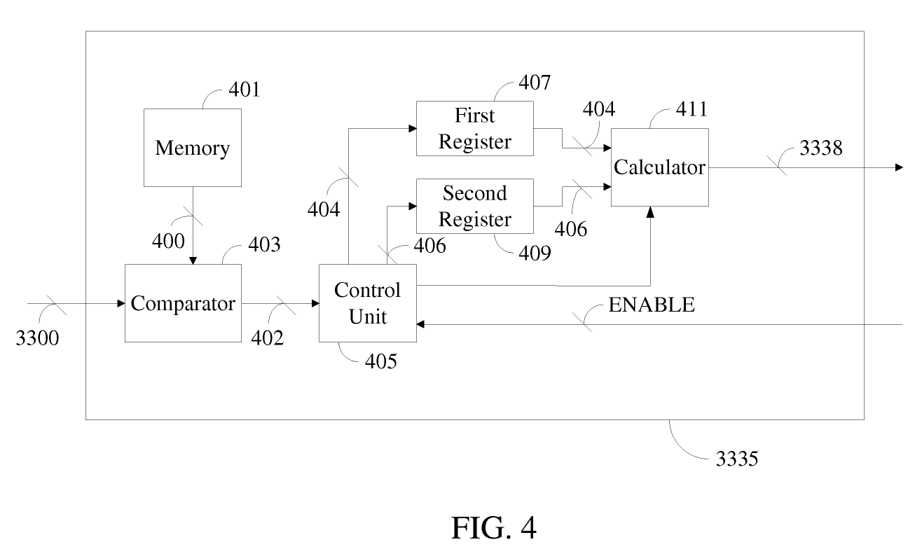

The block diagram of the calibrator 3335 is shown in FIG. 4. The calibrator 3335 comprises a memory 401, a comparator 403, a control unit 405, a first register 407, a second register 409, and a calculator 411. The memory 401 stores a reference data which is an expected data outputted from the latch 3313. The control unit 405, sets an initial value to a minimum value 406 if it is enabled by an ENABLE signal. The comparator 403 derives a difference between the data and the reference data. The control unit 405 determines whether the delay is acceptable according to the difference. If no, the control unit 405 adds the calibration value 3338 by 1. Then the control unit 405 determines whether the delay becomes acceptable until the smallest calibration value 3338 is derived. The smallest calibration value 3338 is stored to the second register 409 to update the minimum value 406. The minimum value 406 is derived thereby.

The control unit 405 sets another initial value as a maximum value 404, and continues adding the calibration value 3338 by 1. The control unit 405 determines whether the delay is still acceptable according to the difference. If yes, the calibration value 3338 continues being added by 1 until the delay becomes unacceptable. If the delay becomes unacceptable, that means the biggest calibration value 3338 is derived and the biggest calibration value 3338 is stored to the first register 407, to update the maximum value 404. The maximum value is derived thereby. Afterwards, the calculator 411 averages the maximum value 404 and the minimum value 406 as the calibration value 3338. The reference clock source 3330 is adjusted in response to the calibration value 3338.

If there is no data stored in the memory device 31 and the digital television 3 asks to test the delay, the calibrator 3335 transmits a signal 36 to the command unit 3315. The command unit 3315 transmits a test data 34 to the memory device 31 through the pad 3301, the PCB trace 35, and the pad 311 in response to the signal 34. Then the command unit 3315 issues a read command to the memory device 31 via the leading wire 38. The memory device 31 sends the test data 34 to the memory controller 33 in response to the read command. The aforementioned delay adjustment can be executed thereby.

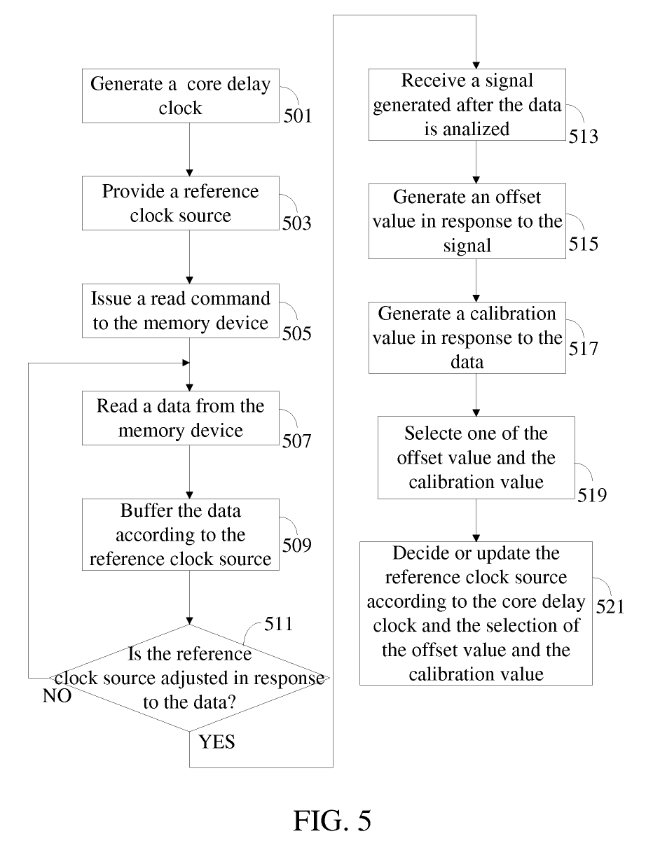

A second embodiment of the present invention is a method for controlling access of a memory device as illustrated in FIG. 5. The second embodiment is adapted for a digital television, such as the digital television 3. The memory device can be a DDR SDRAM or any type of DRAM. The method comprises the following steps. In step 501, a DLL unit, such as the DLL unit 3331, generates a core delay clock. In step 503, a clock adjustment device, such as the clock adjustment device 333 provides a reference clock source in response to the core delay clock. In step 505, a command unit, such as the command unit 3315, issues a read command to the memory device. In step 507, a memory controller, such as the memory controller 33, reads a data from the memory device. In step 509, a storage buffer, such as a latch 3313, buffers the data according to the reference clock source. In step 511, the memory controller determines whether to adjust the reference clock source in response to the data. If no, the method goes back to step 507 to read another data. If yes, step 513 is executed in which an offset unit, such as the offset unit 3333, receives a signal which is generated after the data is analyzed. In step 515, the offset unit generates an offset value in response to the signal. Then step 517 is executed in which a calibrator, such as the calibrator 3335, generates a calibration value in response to the data. In step 519, a multiplexer, such as the multiplexer 3337, selects one of the offset value and the calibration value in response to a command generated from a processing unit of the digital television. In step 521, the reference clock source is decided, or updated, according to the core delay clock and the selection of the offset value and the calibration value. In particular, the core delay clock is added by the selection of the offset value and the calibration value to form the reference clock source.

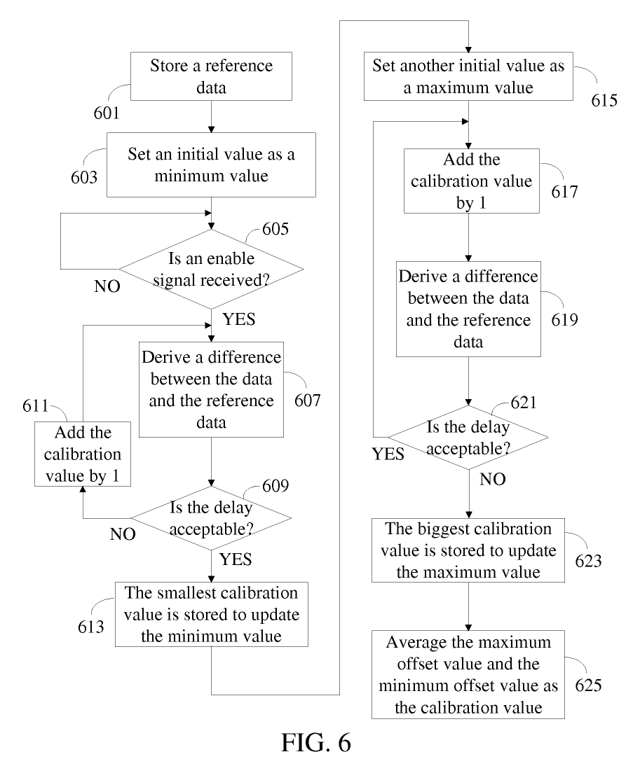

Step 517 further comprises the steps shown in FIG. 6. In step 601, a memory, such as the memory 401 stores a reference data. In step 603, a control unit, such as the control unit 405, sets an initial value a minimum value. In step 605, the calibrator determines whether an enable signal is received. If no, the method goes back to step 605 to wait for the enable signal. If yes, step 607 is executed in which a comparator, such as the comparator 403, derives a difference between the data and the reference data. In step 609, the control unit, such as the control unit 405, determines whether the delay is acceptable according to the difference. If no, step 611 is executed in which the control unit adds the calibration value by 1. Then step 609 is executed again until the smallest calibration value is derived. In step 613, the smallest calibration value is stored to a second register, such as the second register 409 to update the minimum value. In step 615, the control unit sets another initial value as a maximum value. In step 617, the control unit continues adding the calibration value by 1. In step 619, the comparator derives a difference between the data and the reference data. In step 621, the control unit determines whether the delay is still acceptable according to the difference. If yes, the method goes back to step 617 until the delay becomes unacceptable. If the delay becomes unacceptable, that means the biggest calibration value is derived and step 623 is executed in which the biggest calibration value is stored to a first register, such as the first register 407, to update the maximum value. The minimum value and the maximum value are derived thereby. In step 625, a calculator, such as the calculator 411 averages the maximum value and the minimum value as the calibration value. The reference clock source is adjusted in response to the calibration value.

In addition to the steps shown in FIG. 5 and FIG. 6, the second embodiment is capable of performing all the operations or functions recited in the first embodiment. Those skilled in the art can straightforwardly realize how the second embodiment performs these operations and functions based on the above descriptions of the first embodiment. Therefore, the descriptions for these operations and functions are redundant and not repeated herein.

Accordingly, the present invention is capable of dynamically adjusting the reference clock source by monitoring the data outputted from the storage buffer of the memory controller. Therefore, the delay during data access can be maintained.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A memory controller for controlling access of a memory device, comprising:
a storage buffer for buffering a data read from the memory device according to a reference clock source; and
a clock adjustment device for providing the reference clock source and determining whether to adjust the reference clock source in response to the data.

2. The memory controller as claimed in claim 1, wherein the data is read after the clock adjustment device issues a read command to the memory device.

3. The memory controller as claimed in claim 1, wherein the clock adjustment device comprises a delay lock loop (DLL) unit for generating a core delay clock, and the reference clock source is provided in response to the core delay clock.

4. The memory controller as claimed in claim 3, the memory controller being connected to a processing unit, the processing unit analyzing the data and generating a signal after the analysis, wherein the clock adjustment device comprises an offset unit for generating an offset value in response to the signal, and the reference clock source is adjusted in response to the offset value.

5. The memory controller as claimed in claim 4, wherein the offset unit is a register.

6. The memory controller as claimed in claim 3, wherein the clock adjustment device comprises a calibrator for generating a calibration value in response to the data, and the reference clock source is adjusted in response to the calibration value.

7. The memory controller as claimed in claim 6, wherein the calibrator comprises:
a memory for storing a reference data; and
a comparator for deriving a difference between the data and the reference data;
wherein the calibration value is generated in response to the difference.

8. The memory controller as claimed in claim 7, wherein the calibrator comprises:
a first register for storing a maximum value;
a second register for storing a minimum value; and
a control unit for updating the maximum value and the minimum value after analyzing the difference.

9. The memory controller as claimed in claim 8, wherein the calibrator comprises a calculator for deriving the calibration value by averaging the maximum value and the minimum value.

10. The memory controller as claimed in claim 3, the memory controller being connected to a processing unit, the processing unit analyzing the data and generating a signal after the analysis, the clock adjustment device comprising:
an offset unit for generating an offset value in response to the signal;
a calibrator for generating a calibration value in response to the data; and
a multiplexer for selecting one of the offset value and the calibration value in response to a command generated from the processing unit;
wherein the core delay clock and the selection of the offset value and the calibration value decides the reference clock source.

11. A method for controlling access of a memory device, comprising steps of:
providing a reference clock source;
buffering a data read from the memory device according to the reference clock source;
and
determining whether to adjust the reference clock source in response to the data.

12. The method as claimed in claim 11, further comprising a step of issuing a read command to the memory device, wherein the data is read after the issuing step is executed.

13. The method as claimed in claim 11, further comprising a step of generating a core delay clock, wherein the providing step is executed in response to the core delay clock.

14. The method as claimed in claim 13, further comprising steps of:
receiving a signal, the signal being generated after the data is analyzed; and
generating an offset value in response to the signal;
wherein the reference clock source is adjusted in response to the offset value.

15. The method as claimed in claim 13, further comprising a step of:
generating a calibration value in response to the data;
wherein the reference clock source is adjusted in response to the calibration value.

16. The method as claimed in claim 15, wherein the step of generating a calibration value comprises steps of:
storing a reference data; and
deriving a difference between the data and the reference data;
wherein the calibration value is generated in response to the difference.

17. The method as claimed in claim 16, wherein the step of generating a calibration value comprises steps of:
analyzing the difference;
updating a maximum value and a minimum value after analyzing the difference;
averaging the updated maximum value and the updated minimum value; and
outputting the average as the calibration value.

18. The method as claimed in claim 13, further comprising steps of:
receiving a signal, the signal being generated after the data is analyzed;
generating an offset value in response to the signal;
generating a calibration value in response to the data;
selecting one of the offset value and the calibration value; and
deciding the reference clock source according to the core delay clock and the selection of the offset value and the calibration value.

19. A digital television, comprising:
a memory device for storing a data; and
a memory controller for providing a reference clock source, buffering the data read from the memory device according to the reference clock source, and determining whether to adjust the reference clock source in response to the buffered data.

20. The digital television as claimed in claim 19, wherein the data is read after the memory controller issues a read command to the memory device.
